(19) United States
(12) Patent Application Publication
(10) Pub. No.: US 2002/0158757 A1
(43) Pub. Date: Oct. 31, 2002

(54) Vehicle brake light system

(76) Inventor: Jason J. Stubock, Boca Raton, FL (US)

Correspondence Address: Oltman, Flynn & Kubler, John H. Oltman, 915 Middle River Drive #415, Ft. Lauderdale, FL, 33304-3585, US

(21) Appl. No.: 10/134,225

(22) Filed: Apr. 26, 2002

Related U.S. Application Data
(60) Provisional application No. 60/286,605, filed on Apr. 27, 2001.

(51) Int. Cl. B60Q 1/44

(52) U.S. Cl. 340/479; 340/468

(57) ABSTRACT

A vehicle brake light system including a brake light circuit containing a circuit element connected to brake pedal position sensing means so that the brightness of the brake lights or the number of brake lights illuminated depends upon how far the brake pedal is depressed.

### FILING HISTORY

This application continues from provisional application serial No. 60/286,605, filed on Apr. 27, 2001.

### BACKGROUND OF THE INVENTION

1. Field of the Invention

The present invention relates generally to the field of brake light systems for automotive vehicles, such as passenger cars, station wagons, vans and mini-vans, SUV's, trucks, and motorcycles. More specifically the present invention relates to a novel vehicle brake light system in which the brightness of the brake lights depends upon how far the brake pedal is depressed. In accordance with the present invention, the brake lights shine more brightly in the event of a panic stop in which the driver suddenly depresses the brake pedal fully upon perceiving a situation ahead that makes him or her want to bring the vehicle to a stop as quickly as possible. Alternatively, in accordance with the present invention, the brake light shines considerably less brightly when the driver depresses the brake pedal lightly, for example, to slow down the vehicle to bring it under a posted speed limit. Thus, the novel brake light system of this invention improves road safety by enabling the driver of a following vehicle to have a better idea of why the leading vehicle equipped with the present invention has its brake lights on, so that the following driver can act accordingly.

2. Description of the Prior Art

There have long been brake lights on automotive vehicles which are energized from the vehicle battery through a normally-open switch that is closed when the vehicle driver depresses the brake pedal to slow down or bring the vehicle to a stop. The conventional practice is to provide a binary operation of the brake lights—they are either off or fully on. A problem with this prevailing design has been that a driver following a leading vehicle cannot immediately tell whether the leading driver is braking lightly or braking hard, and thus may not apply sufficient braking force in time to avoid colliding with the leading vehicle.

It is thus an object of the present invention to provide a brake light system producing brake light illumination intensity corresponding to the magnitude of brake force applied, so that when a driver of a leading vehicle applies the brakes, a driver of a following vehicle quickly apply his or her brakes with corresponding force and maintain a safe distance between the leading and following vehicles.

It is another object of the present invention to provide such a brake light system which is simple in design and reliable.

It is finally an object of the present invention to provide such a brake light system which is inexpensive to manufacture.

### SUMMARY OF THE INVENTION

The present invention accomplishes the above-stated objectives, as well as others, as may be determined by a fair reading and interpretation of the entire specification.

A brake light system for a vehicle having a brake system including a brake activation mechanism depressible from a fully non-depressed position to a fully depressed position, the brake activation mechanism progressively increasing braking force as the brake activation mechanism is depressed toward the fully depressed position and progressively decreasing braking force as the brake activation mechanism is returned to the fully non-depressed position, the brake activation mechanism being biased toward the fully non-depressed position with a biasing mechanism, the brake light system including a brake light circuit including a brake light source, an electric power source and a voltage regulating mechanism, the voltage regulating mechanism being operationally connected to the brake activation mechanism so that movement of the brake pedal toward the depressed position causes the voltage regulating mechanism to progressively increase the voltage across the brake light source and so that movement of the brake pedal toward the non-depressed position causes the voltage regulating mechanism to progressively decrease the voltage across the brake light source to a limit of substantially no voltage.

The voltage regulating mechanism preferably includes a rheostat. The brake activation mechanism preferably includes a brake pedal mounted to the vehicle to be progressively movable relative to the remainder of the vehicle between the fully depressed position and the fully non-depressed position. The biasing mechanism preferably includes a coil spring.

A vehicle brake system is further provided, including a brake system including a brake activation mechanism depressible from a fully non-depressed position to a fully depressed position, the brake activation mechanism progressively increasing braking force as the brake activation mechanism is depressed toward the fully depressed position and progressively decreasing braking force as the brake activation mechanism is returned to the fully non-depressed position, the brake activation mechanism being biased toward the fully non-depressed position with a biasing mechanism; and a brake light system including a brake light circuit having a brake light source, an electric power source and a voltage regulating mechanism, the voltage regulating mechanism being operationally connected to the brake activation mechanism so that movement of the brake pedal toward the depressed position causes the voltage regulating mechanism to progressively increase the voltage across the brake light source and so that movement of the brake pedal toward the non-depressed position causes the voltage regulating mechanism to progressively decrease the voltage across the brake light source.

The brake activation mechanism preferably includes a brake pedal mounted to the vehicle to be progressively movable relative to the remainder of the vehicle between the fully depressed position and the fully non-depressed position. The voltage regulating mechanism preferably includes a rheostat. The biasing mechanism preferably includes a coil spring.

A vehicle having wheels and vehicle drive mechanism, the vehicle including a braking system for slowing the speed of a vehicle, the braking system including a brake light circuit including a brake light source, an electric power source and a voltage regulating mechanism and circuit wiring electrically interconnecting the brake light source, the electric power source and the voltage regulating mechanism, so that the voltage regulating mechanism regulates the magnitude of voltage across the brake light source produced by the electric power source and thus regulates the brightness with which the brake light source shines; rate indicating mechanism indicating the rate of slowing of the vehicle caused by operation of the braking system, the rate indicating mechanism being operationally connected to the voltage regulating mechanism so that the voltage regulating mechanism delivers progressively increased voltage to the brake light source as the rate of slowing of the vehicle increases and delivers progressively decreasing voltage to the brake light source as the rate of slowing of the vehicle decreases. The voltage regulating mechanism preferably includes a rheostat.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a schematic circuit diagram showing in simplified form a vehicle brake light system in accordance with this invention.

FIG. 2 is a side elevation of a car brake pedal and a brake switch actuator located behind the pedal in accordance with one common practice today in the automotive industry.

FIG. 3 is a view similar to FIG. 2 of a different type of arrangement of the pedal.

FIG. 4 is a longitudinal section through a brake switch actuator for an arrangement as shown in FIG. 3.

FIG. 5 is a front perspective view of a brake system pedal and its pedal mounting structure, showing an example of a mechanical means for operationally connecting the brake pedal mounting structure to a brake light circuit rheostat.

FIG. 6 is a rear perspective view of the system of FIG. 5.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

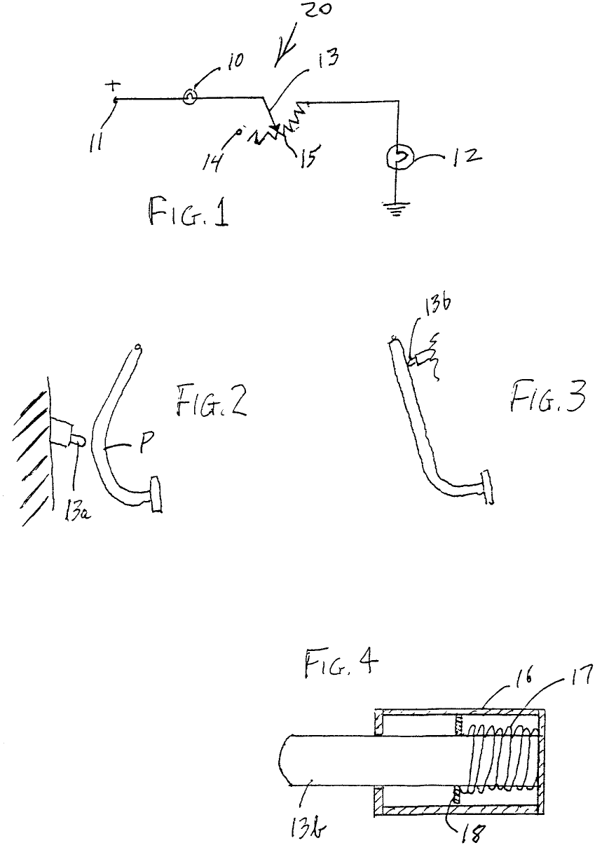

Referring to FIGS. 1-6, a brake light system S is disclosed which includes the usual fuse 10 connected to the positive terminal 11 of the vehicle battery ahead of the brake light 12. For the sake of simplicity only a single brake light 12 is shown but, of course, on a typical car or truck there are two. In accordance with the present invention, connected between the fuse 10 and the brake light 12 is a voltage-varying device 20, here shown for purposes of illustrating the principle of the invention as a rheostat having a resistance 15 engaged by a slidable contact 13 connected to the fuse 10. At the left end of the rheostat resistance 15 in FIG. 1, an open-circuited contact 14 is positioned to be engaged by the slidable contact 13 when the vehicle brake pedal P of the brake activation means is in its normal (i.e. not depressed) position. The opposite end of the rheostat resistance 15 is connected to the brake light 12.

With this arrangement, normally the voltage varying device 20 is open and brake light 12 is not energized. When the driver depresses the brake pedal P, this brings the slidable contact 13 of the voltage varying device 20 into engagement with the rheostat resistance 15 to apply a voltage from the vehicle battery to a brake light 12, turning on brake light 12. The farther the brake pedal P is depressed, the farther the slidable contact 13 moves to the right along the rheostat resistance 15 in FIG. 1 and the higher the voltage applied to the brake light 12 and the brighter it shines.

FIG. 2 shows a known type of voltage varying device 20 arrangement in which the voltage varying device actuator 13a is positioned behind the brake pedal P and is depressed in response to depression of the brake pedal P by the driver of the vehicle. In accordance with the present invention, this voltage varying device actuator 13a is mechanically coupled in any desired manner to the slidable contact 13 of the voltage varying device 20 in FIG. 1 such that the brake light 12 shines more brightly the farther the brake pedal P is depressed.

FIG. 3 shows another known type of voltage varying device 20 arrangement in which the voltage varying device actuator 13b is in front of the brake pedal P. In this case, the voltage varying device actuator 13b may be a plunger that is spring-biased into engagement with the brake pedal P in all positions of the latter. FIG. 4 shows the actuator 13b as a plunger reciprocally received in a cylindrical housing 16 and projecting out of one end of the housing into engagement with the brake pedal P. A coil spring 17 is under compression between the opposite end of the housing and transverse member 18 on plunger actuator 13b. Plunger actuator 13b is mechanically coupled in any desired fashion to the slidable contact 13 of the voltage varying device 20 in FIG. 1 such that this device 20 is open when the brake pedal P is in its normal, non-depressed position and is closed in response to depression of the brake pedal P to provide an energizing voltage for the brake light 12 that varies with the position of the brake pedal P, as described.

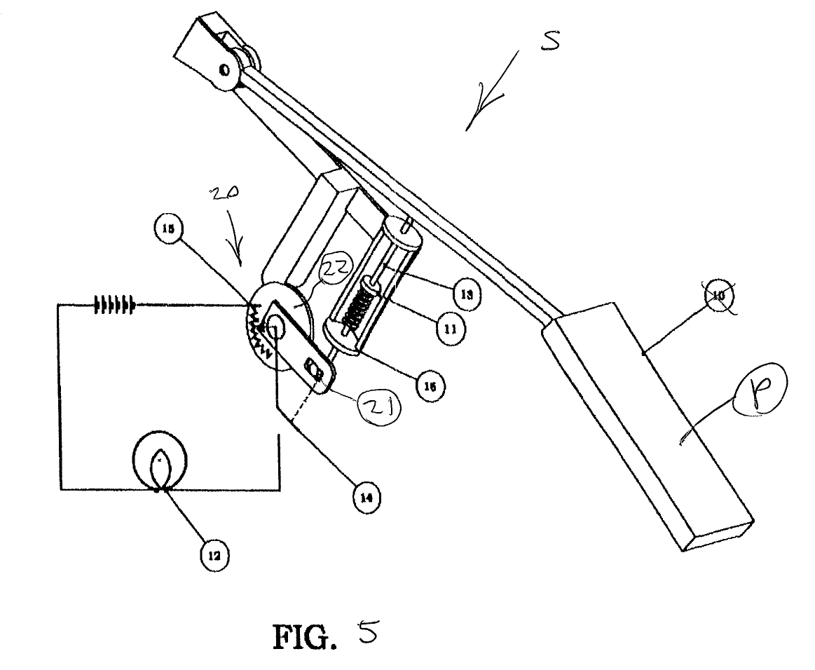

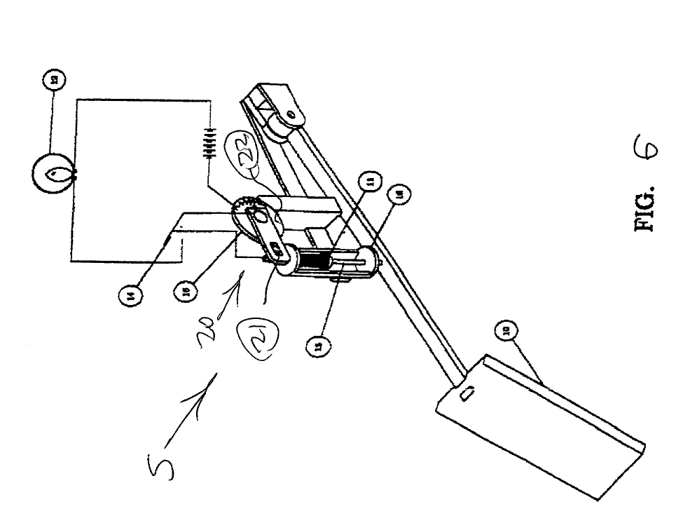

An example of a mechanical means for operating a brake light circuit rheostat is shown in FIGS. 5 and 6, in which the slidable contact 13 angles at its distal end into a port 21 in a rheostat resistor element 15 radial lever extending from a rheostat wheel 22. It is contemplated that the voltage varying element, whether a rheostat or other mechanism, might preferably be constructed to start illumination at a certain clearly visible level, so that there is a voltage step from zero to a pre-set magnitude.

It is to be understood that the voltage-varying brake light switch 12 may differ from the rheostat-type voltage varying device shown schematically in FIG. 1 to illustrate the principle of operation of this system S. Also, the energization circuit for the brake light 12 may differ from the one shown in FIG. 1, and instead of sensing the brake pedal's P position mechanically, an optical or infrared sensor arrangement might be provided to control the energization of the brake light 12 in accordance with the sensed position of the brake pedal P.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A brake light system for a vehicle having a brake system comprising a brake activation means depressible from a fully non-depressed position to a fully depressed position, the brake activation means progressively increasing braking force as the brake activation means is depressed toward the fully depressed position and progressively decreasing braking force as the brake activation means is returned to the fully non-depressed position, the brake activation means being biased toward the fully non-depressed position with biasing means, said brake light system comprising:
a brake light circuit comprising a brake light source, an electric power source and a voltage regulating means, said voltage regulating means being operationally connected to said brake activation means such that movement of said brake pedal toward said depressed position causes said voltage regulating means to progressively increase the voltage across said brake light source from a certain pre-set level and such that movement of said brake pedal toward said non-depressed position causes said voltage regulating means to progressively decrease the voltage across said brake light source to a limit of substantially no voltage.

2. The brake light system of claim 1, wherein said voltage regulating means comprises a rheostat.

3. The brake light system of claim 1, wherein said brake activation means comprises a brake pedal mounted to the vehicle to be progressively movable relative to the remainder of the vehicle between the fully depressed position and the fully non-depressed position.

4. The brake light system of claim 1, wherein said biasing means comprises a coil spring.

5. A vehicle brake system, comprising:
a brake system comprising a brake activation means depressible from a fully non-depressed position to a fully depressed position, said brake activation means progressively increasing braking force as said brake activation means is depressed toward the fully depressed position and progressively decreasing braking force as said brake activation means is returned to the fully non-depressed position, said brake activation means being biased toward the fully non-depressed position with biasing means;
and a brake light system comprising a brake light circuit comprising a brake light source, an electric power source and a voltage regulating means, said voltage regulating means being operationally connected to said brake activation means such that movement of said brake pedal toward said depressed position causes said voltage regulating means to progressively increase the voltage across said brake light source and such that movement of said brake pedal toward said non-depressed position causes said voltage regulating means to progressively decrease the voltage across said brake light source.

6. The brake light system of claim 5, wherein said brake activation means comprises a brake pedal mounted to the vehicle to be progressively movable relative to the remainder of the vehicle between the fully depressed position and the fully non-depressed position.

7. The brake light system of claim 5, wherein said voltage regulating means comprises a rheostat.

8. The brake light system of claim 5, wherein said biasing means comprises a coil spring.

9. A vehicle having wheels and vehicle drive means, the vehicle comprising:
braking means for slowing the speed of a vehicle, said braking means comprising a brake light circuit including a brake light source, an electric power source and a voltage regulating means and circuit wiring electrically interconnecting said brake light source, said electric power source and said voltage regulating means, such that said voltage regulating means regulates the magnitude of voltage across said brake light source produced by said electric power source and thus regulates the brightness with which said brake light source shines;
rate indicating means indicating the rate of slowing of the vehicle caused by operation of said braking means, said rate indicating means being operationally connected to said voltage regulating means such that said voltage regulating means delivers progressively increased voltage to said brake light source as the rate of slowing of the vehicle increases and delivers progressively decreasing voltage to said brake light source as the rate of slowing of the vehicle decreases.

10. The brake light system of claim 9, wherein said voltage regulating means comprises a rheostat.
